(19) United States
(12) Patent Application Publication
(10) Pub. No.: US 2022/0067853 A1
(43) Pub. Date: Mar. 3, 2022

(54) ENERGY EQUIPMENT DETERMINATION DEVICE AND ENERGY EQUIPMENT DETERMINATION METHOD

(71) Applicant: YAZAKI ENERGY SYSTEM CORPORATION, Tokyo (JP)

(72) Inventors: Yohsuke Yamada, Hamamatsu-shi (JP); Motomi Inagaki, Hamamatsu-shi (JP)

(21) Appl. No.: 17/458,553

(22) Filed: Aug. 27, 2021

(30) Foreign Application Priority Data
Aug. 28, 2020 (JP) 2020-144166

(51) Int. Cl. G06Q 50/06; G05B 19/042

(52) U.S. Cl. CPC G06Q 50/06; G05B 2219/2639; G05B 19/042

(57) ABSTRACT

An energy equipment determination device includes an initial group determination unit that determines a plurality of candidates of an equipment condition, an operation condition, and a control condition, and sets the plurality of candidates as an initial group, a Pareto solution group calculation unit that applies the initial group determined by the initial group determination unit to a genetic algorithm, and calculates a Pareto solution group when a primary energy consumption and a system cost including an initial cost and a running cost are objective functions, and a financial index calculation unit that calculates a net present value after a specific period from introduction and an internal profit rate after the specific period from the introduction when energy equipment that individually indicates the plurality of Pareto solutions calculated by the Pareto solution group calculation unit is introduced.

### CROSS-REFERENCE TO RELATED APPLICATIONS

This application is based on and claims priority under 35 USC 119 from Japanese Patent Application No. 2020-144166 filed on Aug. 28, 2020, the contents of which are incorporated herein by reference.

### TECHNICAL FIELD

The present invention relates to an energy equipment determination device and an energy equipment determination method.

### BACKGROUND ART

In the related art, it has been proposed to optimize energy equipment such as a gas engine, an absorption type water cooler/heater, and an air-cooling heat pump and a control method thereof by using a genetic algorithm (see, for example, Non-Patent Literature 1). According to this method, it is possible to obtain a Pareto solution group (a group of optimal solution candidates) in which a system costs including an initial cost and a running cost and primary energy consumption are used as objective functions and the system cost and the primary energy consumption are further reduced.

### CITATION LIST

Non-Patent Literature 1: Architectural Institute of Japan's Journal of Environmental Engineering, Vol. 75, Issue 654, pp. 735-740, published in August 2010, multi-objective genetic algorithm optimized for energy consumption and cost in building energy system design written by Genku Kayo, Ryozo Ooka

However, such a Pareto solution group merely means that the system cost and the primary energy consumption are smaller, and it is unclear whether the solution is a good investment-efficient solution. Therefore, even if the energy equipment is introduced for the reason that the system cost and the primary energy consumption are smaller, there is no financial merit on an introduction side of the energy equipment, and a loss may occur.

### SUMMARY OF INVENTION

The present invention has been made in order to solve such related-art problems, and an object thereof is to provide an energy equipment determination device and an energy equipment determination method capable of presenting information on a financial merit to an introduction side of energy equipment in determining the energy equipment in which a system cost and a primary energy consumption are smaller.

An energy equipment determination device according to the present invention includes: an initial group determination unit configured to determine a plurality of candidates of an equipment condition indicating a type and size of energy equipment, an operation condition serving as an external factor during operation of the energy equipment, and a control condition during the operation of the energy equipment, and set the plurality of candidates as an initial group; a Pareto solution group calculation unit configured to apply the initial group determined by the initial group determination unit to a genetic algorithm, and calculate a Pareto solution group that is a group of a plurality of Pareto solutions when the primary energy consumption and the system cost including the initial cost and the running cost are objective functions; and a financial index calculation unit configured to calculate a financial index of at least one of a net present value after a specific period from introduction and an internal profit rate after the specific period from the introduction w % ben the energy equipment that individually indicates the plurality of Pareto solutions calculated by the Pareto solution group calculation unit is introduced.

Further, an energy equipment determination method of an energy equipment determination device according to the present invention includes: an initial group determination step configured to determine a plurality of candidates of an equipment condition indicating a type and size of energy equipment, an operation condition serving as an external factor during operation of the energy equipment, and a control condition during the operation of the energy equipment, and set the plurality of candidates as an initial group; a Pareto solution group calculation step configured to apply the initial group determined by the initial group determination step to a genetic algorithm, and calculate a Pareto solution group that is a group of a plurality of Pareto solutions when the primary energy consumption and the system cost including the initial cost and the running cost are objective functions; and a financial index calculation step configured to calculate a financial index of at least one of a net present value after a specific period from introduction and an internal profit rate after the specific period from the introduction when the energy equipment that individually indicates the plurality of Pareto solutions calculated by the Pareto solution group calculation step is introduced.

### BRIEF DESCRIPTION OF DRAWINGS

FIG. 1 is a conceptual diagram of processing performed by an energy equipment determination device according to an embodiment of the present invention.

FIG. 2 is a functional configuration diagram of the energy equipment determination device according to the embodiment of the present invention.

FIGS. 3A to 3E are conceptual diagrams illustrating a processing outline of a genetic algorithm, wherein FIG. 3A illustrates an initial group, FIG. 3B illustrates an evaluation step, FIG. 3C illustrates a selection and elimination step, FIG. 3D illustrates a crossover step, and FIG. 3E illustrates a mutation step.

FIG. 4 is a conceptual diagram illustrating a state in which a Pareto solution group is calculated.

FIG. 5 is a configuration diagram illustrating details of a storage unit illustrated in FIG. 1.

FIG. 6 is a conceptual diagram illustrating a net present value and an internal profit rate.

FIGS. 7A and 7B are charts illustrating a net present value in ten years and an internal profit rate within ten years, wherein FIG. 7A illustrates a first example, and FIG. 7B illustrates a second example.

FIG. 8 is a conceptual diagram illustrating a display example of a financial index calculated by a financial index calculation unit and an expected value.

FIG. 9 is a flowchart illustrating an energy equipment determination method according to the present embodiment.

### DESCRIPTION OF EMBODIMENTS

Hereinafter, the present invention will be described in accordance with a preferred embodiment. The present invention is not limited to the following embodiment, and can be modified as appropriate without departing from the scope of the present invention. In the embodiment described below, some configurations are not illustrated or described, but it goes without saying that a known or well-known technique is applied as appropriate to details of an omitted technique within a range in which no contradiction occurs to contents described below.

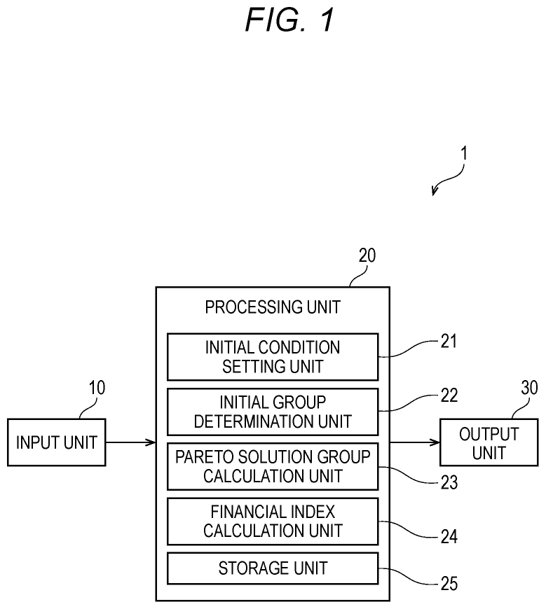

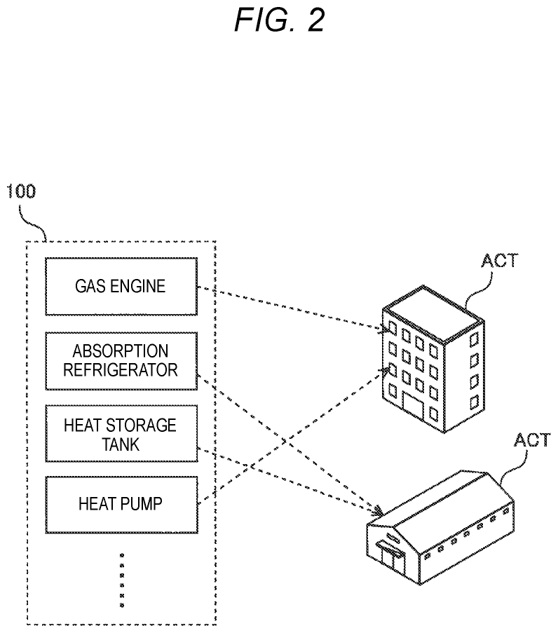

FIG. 1 is a conceptual diagram of processing performed by an energy equipment determination device according to an embodiment of the present invention, and FIG. 2 is a functional configuration diagram of the energy equipment determination device according to the embodiment of the present invention. As illustrated in FIG. 2, the energy equipment determination device 1 illustrated in FIG. 1 determines energy equipment 100 suitable for an air-conditioning target ACT such as a building that should be air-conditioned, and determines appropriate energy equipment 100 based on a region in which the air-conditioning target ACT is present, an air-conditioning load, or the like.

The energy equipment determination device 1 determines, as the appropriate energy equipment 100, energy equipment 100 having minimum primary energy consumption and a minimum system cost including an initial cost and a running cost from energy equipment 100 of various types and sizes (output capacities such as a refrigeration capacity, a heating capacity, and a power generation capacity).

Types (major classification) of the energy equipment 100 include various types such as a radiator, a solar energy utilization device, an auxiliary heat source, and an exhaust heat utilization device, in addition to a gas engine, an absorption refrigerator, a heat storage tank, and a heat pump. Types (small classification) of the energy equipment 100 include, for example, a vaporization/liquefaction heat pump, a sterling heat pump, a chemical heat pump, as well as an air-cooled heat pump, a water-cooled heat pump, or the like, in the heat pump. The same applies to the other energy equipment 100.

Further, each type of the energy equipment 100 has various levels of refrigeration capacity or the like. Therefore, there may be innumerable possible combinations of energy equipment 100 for the air-conditioning target ACT.

Therefore, the energy equipment determination device 1 according to the present embodiment uses a genetic algorithm to obtain a Pareto solution group which is a group of a plurality of Pareto solutions indicating more appropriate energy equipment 100 from the innumerable combinations of the energy equipment 100. In addition, the energy equipment determination device 1 according to the present embodiment is configured to calculate a financial index in a case where the energy equipment 100 indicated by each of a plurality of Pareto solutions is introduced as a characteristic configuration. Such an energy equipment determination device 1 includes an input unit 10, a processing unit 20, and an output unit 30.

The input unit 10 includes an operation unit or the like operated by a user who uses the energy equipment determination device 1. An initial condition, an initial group, or the like are input to the input unit 10. The processing unit 20 functions by executing an energy equipment determination program, and includes an initial condition setting unit 21, an initial group determination unit 22, a Pareto solution group calculation unit 23, a financial index calculation unit 24, and a storage unit 25.

The energy equipment determination program may be stored in the storage unit 25 in advance, or may be a program recorded in a recording medium such as a USB memory or a CD-ROM and newly downloaded and stored in the storage unit 25. Further, the energy equipment determination program may be downloaded through a network and stored in the storage unit 25.

The output unit 30 outputs calculation results or the like calculated by the Pareto solution group calculation unit 23 and the financial index calculation unit 24 to the user, and is configured with, for example, a display device such as a display or a printing machine of a paper medium such as a printer. Further, the output unit 30 may include a communication unit that outputs a result by e-mail or the like.

The initial condition setting unit 21 sets initial conditions including a weather condition of a region where the energy equipment 100 is used and an air-conditioning load condition to be obtained by the energy equipment 100. The weather condition is, for example, a condition such as an air temperature or a sunshine time for each season, and the air-conditioning load condition is a condition of a set temperature set for a building material specification of the air-conditioning target ACT, a size of an indoor space, a layout, and comfort. Since the air-conditioning load is also affected by an outside air temperature, both may be set as one related condition. Further, the initial condition setting unit 21 is not limited to setting both the weather condition and the air-conditioning load condition as the initial condition, and may set any one of the weather conditions and the air-conditioning load condition as the initial condition. Further, the initial condition setting unit 21 may set, as the initial condition, conditions other than the above (for example, a region condition indicating a region, an unusable equipment condition indicating the energy equipment 100 that cannot be installed due to a relationship of a site area, a request of an introducer side, or the like).

The initial group determination unit 22 determines a plurality of candidates of an equipment condition indicating the type and size of the energy equipment 100, an operation condition serving as an external factor during operation of the energy equipment 100, and a control condition during the operation of the energy equipment 10, and sets the plurality of candidates as an initial group. The operation condition serving as the external factor during the operation of the energy equipment 100 include a temperature of cooling water of the absorption refrigerator, a temperature of a heating medium of the gas engine, or the like, and are not control targets of the energy equipment 100 in principle. The control condition for operating the energy equipment 100 include a timing of pump control of a heat medium, an absorbing liquid, or the like, a timing of opening and closing of various valves, or the like, and is a control target in the energy equipment 100.

Here, the initial group is restricted by the initial condition. That is, the initial group determination unit 22 determines the candidate of the operation condition based on the weather condition that is the initial condition, and determines the candidate of the equipment condition based on the air-conditioning load condition that is the initial condition. More specifically, for example, when the outside air temperature is set according to the weather condition, the temperature of the cooling water is limited in a temperature range, and is determined as a candidate from a narrower temperature range as compared with a case where the weather condition is not set. Similarly, if a large air-conditioning load is set according to the air-conditioning load condition, only larger energy equipment 100 is determined as a candidate for the size of the energy equipment 100.

The Pareto solution group calculation unit 23 applies the initial group determined by the initial group determination unit 22 to the genetic algorithm, and calculates the Pareto solution group which is a group of the plurality of Pareto solutions when the primary energy consumption and the system cost including the initial cost and the running cost are objective functions.

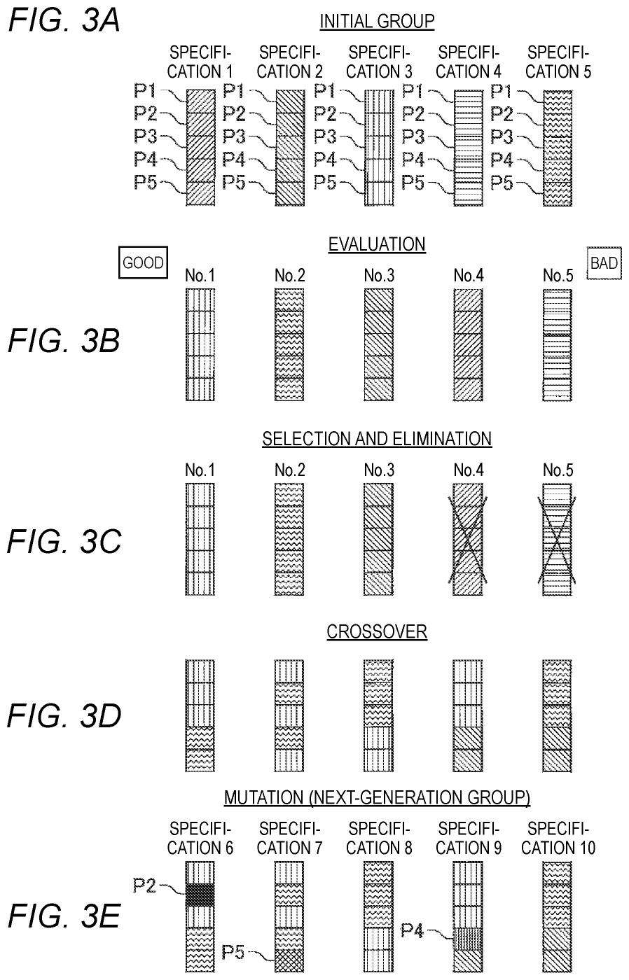

FIGS. 3A to 3E are conceptual diagrams illustrating a processing outline of the genetic algorithm, wherein FIG. 3A illustrates an initial group, FIG. 3B illustrates an evaluation step, FIG. 3C illustrates a selection step, FIG. 3D illustrates a crossover step, and FIG. 3E illustrates a mutation step. In FIGS. 3A to 3E, an example in which the number of specifications of the initial group is five will be described, but the number of specifications of the initial group is preferable, for example, about 20 to 30.

First, as illustrated in FIG. 3A, the initial group determination unit 22 determines the initial group having five specifications within the range of the initial condition set by the initial condition setting unit 21. Each specification includes information (candidates) of various conditions P1 to P5 (the equipment condition, the operation condition, and the control condition). These various conditions P1 to P5 are regarded as genes.

Next, as illustrated in FIG. 3B, the Pareto solution group calculation unit 23 performs evaluation. At this time, the Pareto solution group calculation unit 23 calculates the primary energy consumption and the system cost based on a function stored in the storage unit 25 in advance, and ranks the specifications by giving the one with an extremely small primary energy consumption and an extremely low system cost including the initial cost and the running cost a high evaluation.

Next, as illustrated in FIG. 3C, the Pareto solution group calculation unit 23 performs selection and elimination. At this time, the Pareto solution group calculation unit 23 sets an upper side in the rank as a selected target and sets a lower side as an eliminated target. The specification as the eliminated target is deleted (that is, as an individual where the gene is not kept).

Thereafter, as illustrated in FIG. 3D, the Pareto solution group calculation unit 23 performs crossover for the specifications as the selected targets, and forms five groups again. At this time, the various conditions P1 to P5 illustrated in FIG. 3A are scattered. That is, new specifications are created such that the gene of each individual is inherited by interaction.

Next, as illustrated in FIG. 3E, the Pareto solution group calculation unit 23 performs mutation. That is, the Pareto solution group calculation unit 23 mutates any one of the various conditions P1 to P5 of each specification to anew one. In the example illustrated in FIG. 3E, for example, the condition P2 of Specification 6, the condition P5 of Specification 7, and the condition P4 of Specification 9 are mutated. Incidentally, the mutation is preferably restricted by the initial condition as in the initial group. As described above, a group that is mutated is regarded as a next-generation group. Thereafter, the processing returns to FIG. 3B, and the processing from the evaluation to the formation of the next-generation group by mutation is repeatedly executed.

As described above, by repeatedly executing the processing from the evaluation to the formation of the next-generation group by mutation, excellent genes are inherited without being eliminated, and a Pareto solution group which is a group of more appropriate Pareto solutions is calculated.

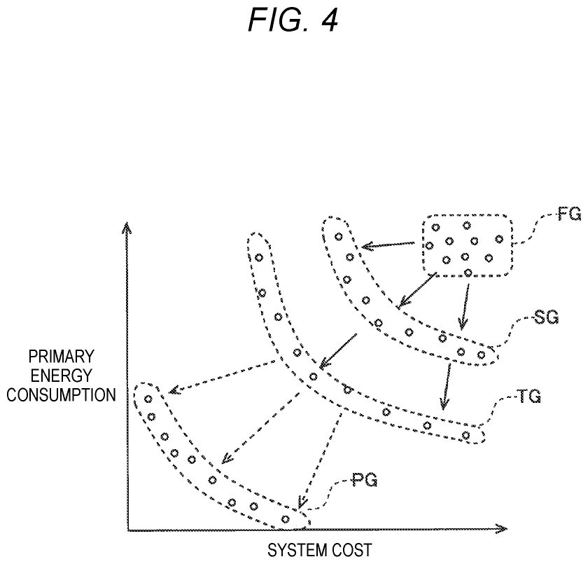

FIG. 4 is a conceptual diagram illustrating a state in which a Pareto solution group is calculated. As illustrated in FIG. 4, first, an initial group FG is determined. This initial group FG is not very good overall in the evaluation, and the primary energy consumption used is large and the system cost is high.

Thereafter, a second generation group SG is formed by selection, elimination, and mutation. Apart in the second generation group SG may be poorer in evaluation than apart in the initial group FG. However, a part which is evaluated more highly after mutation exists, and such a part has low primary energy consumption and low system cost, as in the second generation group SG illustrated in FIG. 4.

Next, similarly, a third generation group TG is formed by selection, elimination, and mutation. Similarly, in the third generation group TG, a group which is evaluated more highly (a part with low primary energy consumption and a low system cost) may be generated.

By repeating the above, excellent specifications will be gradually generated. Therefore, it is possible to obtain a Pareto solution group PG which is a group of a plurality of more appropriate Pareto solutions from a small number of initial groups without forming all specifications for a large number of combinations.

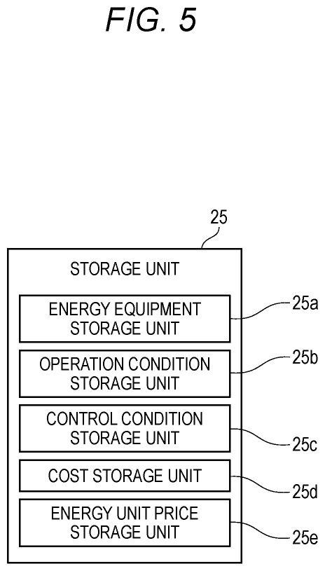

FIG. 5 is a configuration diagram illustrating details of the storage unit 25 illustrated in FIG. 1. As illustrated in FIG. 5, the storage unit 25 includes an energy equipment storage unit 25a, an operation condition storage unit 25b, a control condition storage unit 25c, a cost storage unit 25d, and an energy unit price storage unit 25e.

The energy equipment storage unit 25a stores information such as candidates of the type and size of the energy equipment 100. The operation condition storage unit 25b stores information such as candidates of the external factor during the operation of the energy equipment 100. The control condition storage unit 25c stores information such as candidates of the control condition during the operation of the energy equipment 100. Storage contents of the energy equipment storage unit 25a, the operation condition storage unit 25b, and the control condition storage unit 25c are used for the formation of the initial group FG and the processing of the mutation.

The cost storage unit 25d stores information on the initial cost at the time of introduction of each energy equipment 100 (a cost of the energy equipment 100 itself and a construction cost) and the running cost required for maintenance (a maintenance cost). The energy unit price storage unit 25e stores prices of primary energy such as electricity, gas, and water for each region or each country. The stored contents of the cost storage unit 25d and the energy unit price storage unit 25e are used for the evaluation illustrated in FIG. 3B (similar to plots in FIG. 4). Since the unit of the primary energy consumption, which is a vertical axis illustrated in FIG. 4, is different for each of electricity, gas, water, or the like, the primary energy is converted into a price or converted into any one of the primary energies and indicated by the vertical axis.

FIG. 1 will be referred to again. When the energy equipment 100 that individually indicates the plurality of Pareto solutions calculated by the Pareto solution group calculation unit 23 is introduced, the financial index calculation unit 24 calculates a financial index of at least one of a net present value after a specific period from the introduction and an internal profit rate after the specific period from the introduction.

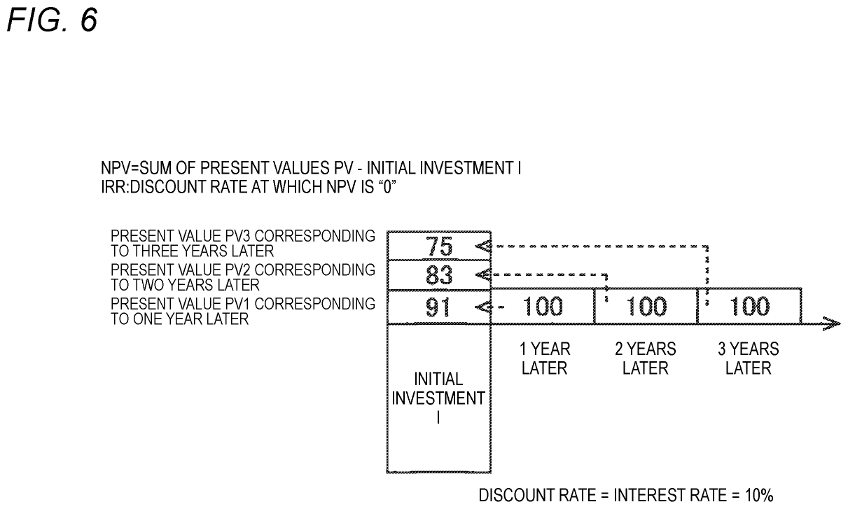

FIG. 6 is a conceptual diagram illustrating the net present value and the internal profit rate. As illustrated in FIG. 6, the net present value NPV indicates a difference between a sum of present values PV within each year and an initial investment I. For example, a value of “100” in one year can be said to be a value of “91” on an assumption that a discount rate (assumed to be an interest rate in the present embodiment) is 10%. For example, when 910,000 yen is deposited in a bank with an interest rate of 10%, one year later 910,000 yen becomes 1,000,000 yen. Therefore, 1,000,000 yen in one year can be said to have the same value as the present 910,000 yen, and this value is a present value PV1. Similarly, a present value PV2 corresponding to the value of “100” in two years is “83”, and a present value PV3 corresponding to the value of “100” after three years is “75”. Here, if the initial investment i is “200”, the net present value NPV in three years is “91+83+75”−“200”=“49”.

An internal profit ratio IRR refers to a discount rate at which the net present value NPV is “0”. That is, although the net present value NPV is “49” in the example illustrated in FIG. 6, the discount rate at which “49” becomes “0” is the internal profit ratio IRR. Therefore, the internal profit ratio IRR is a value lower than 10%.

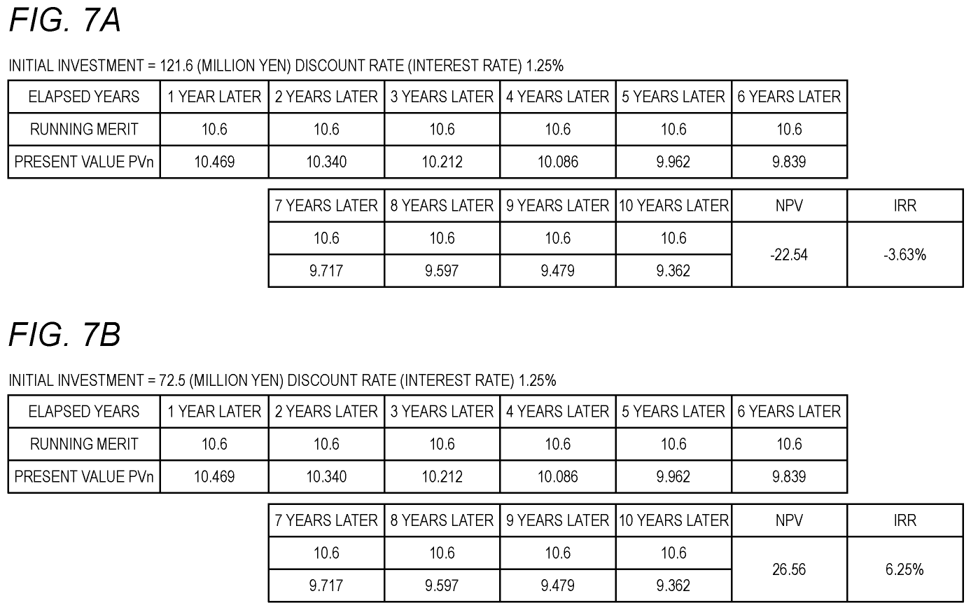

In the present embodiment, the financial index calculation unit 24 calculates a financial index of at least one of the net present value NPV in ten years and the internal profit rate IRR within ten years. FIGS. 7A and 7B are charts illustrating the net present value NPV in 10 years and the internal profit rate IRR within ten years, wherein FIG. 7A illustrates a first example, and FIG. 7B illustrates a second example.

In the examples illustrated in FIGS. 7A and 7B, it is assumed that running merits (that is, the cost of the primary energy reduced by the use of the energy equipment 100) are all “10.6” million yen from in one year to in ten years, and the discount rate (interest rate) is 1.25%. Further, in the first example illustrated in FIG. 7A, the initial investment i is assumed to be “121.6” million yen, and in the second example illustrated in FIG. 7B, the initial investment I is assumed to be “72.5” million yen as a result of the grant of subsidies or the like.

As illustrated in FIGS. 7A and 7B, the present value PV1 corresponding to in one year is “10.469”, the present value PV2 corresponding to in two years is “10.340”, and the present value PV3 corresponding to in three years is “10.212”. Further, a present value PV4 corresponding to in four years is “10.086”, a present value PV5 corresponding to in five years is “9.962”, and a present value PV6 corresponding to in six years is “9.839”.

Further, a present value PV7 corresponding to in seven years is “9.717”, a present value PV8 corresponding to in eight years is “9.597”, a present value PV9 corresponding to in nine years is “9.479”, and a present value PV10 corresponding to in ten years is “9.362”.

Therefore, the net present value NPV in the first example is “−22.54”, and the internal profit ratio IRR is “−3.63%”. In the second example in which the initial investment I is different, the net present value NPV is “26.56”, and the internal profit ratio IRR is “6.25%”.

As described above, the financial index calculation unit 24 calculates the financial index of at least one of the net present value NPV in ten years and the internal profit rate IRR within ten years. Further, the financial index calculation unit 24 calculates information comparing the calculated financial index with a target value (an expected value) of the financial index expected by an introduction side of the energy equipment 100. The expected value is input via the input unit 10.

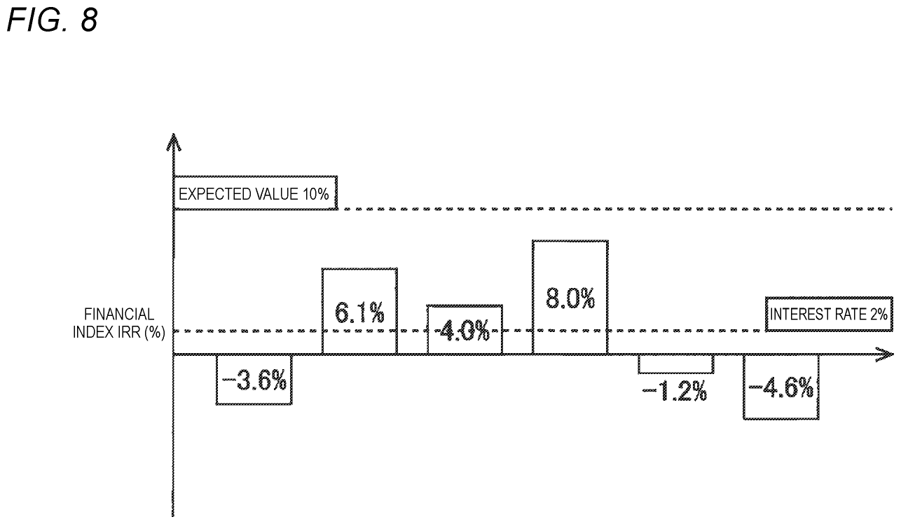

FIG. 8 is a conceptual diagram illustrating a display example of the financial index calculated by the financial index calculation unit 24 and the expected value. In the example illustrated in FIG. 8, the internal profit rate IRR is displayed as the financial index. As illustrated in FIG. 8, the output unit 30 displays the internal profit rate IRR for the energy equipment 100 indicated by each Pareto solution constituting the Pareto solution group PG, and displays the expected value in a comparable way. Further, the output unit 30 also displays the interest rate serving as the discount rate.

Here, the energy equipment 100 where the internal profit rate IRR is negative is in a damaged state even when used for ten years. Further, for the energy equipment 100 where the internal profit rate IRR does not exceed the interest rate, it is not necessary to purposely make an investment in the energy equipment 100, and it cannot be said that the investment effect is excellent.

With such a display, for example, the introducer of the energy equipment 100 can determine the introduction of the energy equipment 100 having the highest internal profit rate IRR. Alternatively, when the internal profit rate IRR is negative in all the energy equipment 100, the introduction of the energy equipment 100 itself can be given up. Further, not only the introducer side but also a sales side can recommend the energy equipment 100 that is the most advantageous for the introducer with reference to the internal profit rate IRR. Further, the sales side can also recommend reviewing the overall system when the energy equipment 100 or the like specified by the introducer has no financial merit.

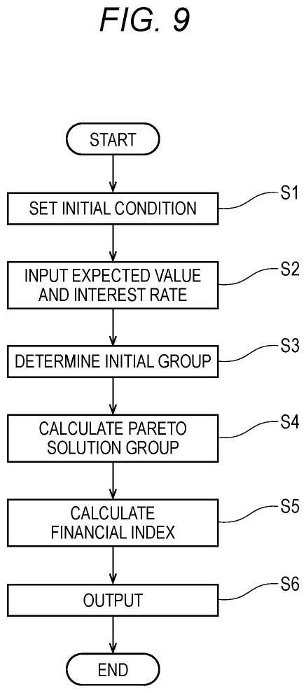

Next, an energy equipment determination method according to the present embodiment will be described. FIG. 9 is a flowchart illustrating the energy equipment determination method according to the present embodiment.

As illustrated in FIG. 9, first, a user of the energy equipment determination device 1, such as a person who considers introduction of the energy equipment 100, sets an initial condition via the input unit 10 (S1). Next, the user inputs the expected value and the interest rate via the input unit 10 (S2). Next, the initial group determination unit 22 determines the initial group FG corresponding to the initial condition set in step S1 (S3).

Next, the Pareto solution group calculation unit 23 calculates the Pareto solution group PG as described with reference to FIGS. 3A to 3E (S4). Next, the financial index calculation unit 24 calculates the financial index when the energy equipment 100 indicated by each Pareto solution of the Pareto solution group PG is introduced (S5). Thereafter, the output unit 30 displays or prints an image indicating the financial index, the expected value, the interest rate (discount rate), a name and a part number of the energy equipment 100, the initial cost, the running cost, the running merit, or the like so as to output the image (S6). Thereafter, the processing illustrated in FIG. 9 ends.

In this way, according to the energy equipment determination device 1 and the method of the present embodiment, when the energy equipment 100 that individually indicates the plurality of Pareto solutions is introduced, a financial index of at least one of the net present value NPV after a specific period from the introduction and the internal profit rate IRR after the specific period from the introduction are calculated. For this reason, not only the primary energy consumption and the system cost become clear for each Pareto solution, but also the financial index becomes clear, and information of the financial merit can be provided to the introducer side. Therefore, when determining the energy equipment 100 in which the system cost and the primary energy consumption are smaller, it is possible to present information on the financial merit to the introduction side of the energy equipment 100.

In the present embodiment, the Pareto solution group PG has a smaller primary energy consumption and a smaller system cost. That is, the Pareto solution group PG is obtained as a two-dimensional solution. Here, the Pareto solution group PG can be included in the financial index and obtained as a three-dimensional solution. However, in the present embodiment, a financial index is calculated after the two-dimensional solution is obtained, instead of obtaining the three-dimensional solution. As a result of intensive studies by inventors of the present case, it has been found that, when an attempt is made to obtain the three-dimensional solution by using a genetic algorithm, a local solution is easily obtained, and there is a high possibility that any one of the primary energy consumption, the system cost, and the financial index is not appropriate. Therefore, in the present embodiment, it is possible to easily obtain an optimal solution by calculating the financial index after obtaining the two-dimensional solution.

Further, since the candidate of the operation condition and the candidate of the equipment condition are determined based on the set initial condition, when the introducer side sets the air-conditioning target ACT such as the region into which the energy equipment 100 is introduced or the building into which the energy equipment 100 is introduced, the appropriate candidate of the operation condition and the appropriate candidate of the equipment condition are obtained, and it is possible to optimize the initial group FG.

Further, since the information obtained by comparing the calculated financial index with the target value of the financial index expected by the introducer side of the energy equipment 100 is calculated, it is possible to clarify whether the equipment can be introduced as expected, and present information on a clearer merit to the introduction side of the energy equipment 100.

According to the present invention, when the energy equipment that individually indicates the plurality of Pareto solutions is introduced, a financial index of at least one of the net present value after a specific period from the introduction and the internal profit rate after the specific period from the introduction are calculated. For this reason, not only the primary energy consumption and the system cost become clear for each Pareto solution, but also the financial index becomes clear, and information of the financial merit can be provided for the introducer side. Therefore, when determining the energy equipment in which the system cost and the primary energy consumption are smaller, it is possible to present information on the financial merit to the introduction side of the energy equipment.

Although the present invention has been described above based on the embodiment, the present invention is not limited to the above embodiment, and various modifications may be made without departing from the spirit of the present invention and publicly-known or well-known techniques may be appropriately combined.

For example, the energy equipment determination device 1 according to the present embodiment determines the initial group FG from candidates of the equipment condition, the operation condition, and the control condition, but the present invention is not limited thereto and may include other conditions. Further, the initial condition may include other conditions as well.

Further, in the present embodiment, the two-dimensional solution between the primary energy consumption and the system cost is obtained by the genetic algorithm, but a three-dimensional or higher-dimensional solution for other items within the range that does not include the financial index may be obtained.

What is claimed is:

1. An energy equipment determination device comprising:
an initial group determination unit configured to determine a plurality of candidates of an equipment condition indicating a type and size of an energy equipment, an operation condition serving as an external factor during operation of the energy equipment, and a control condition during the operation of the energy equipment, and set the plurality of candidates as an initial group;
a Pareto solution group calculation unit configured to apply the initial group determined by the initial group determination unit to a genetic algorithm, and calculate a Pareto solution group that is a group of a plurality of Pareto solutions when the primary energy consumption and the system cost including the initial cost and the running cost are objective functions; and
a financial index calculation unit configured to calculate a financial index of at least one of a net present value after a specific period from introduction and an internal profit rate after the specific period from the introduction when the energy equipment that individually indicates the plurality of Pareto solutions calculated by the Pareto solution group calculation unit is introduced.

2. The energy equipment determination device according to claim 1, further comprising:
an initial condition setting unit configured to set an initial condition including a weather condition of a region where the energy equipment is used and an air-conditioning load condition to be obtained by the energy equipment,
wherein the initial group determination unit is configured to determine a candidate of the operation condition based on the weather condition when the initial condition includes the weather condition, and is configured to determine a candidate of the equipment condition based on the air-conditioning load condition when the initial condition includes the air-conditioning load condition.

3. The energy equipment determination device according to claim 1,
wherein the financial index calculation unit is configured to calculate information obtained by comparing the calculated financial index with a target value of the financial index expected by an introducer side of the energy equipment.

4. An energy equipment determination method of an energy equipment determination device, the energy equipment determination method comprising:
an initial group determination step configured to determine a plurality of candidates of an equipment condition indicating a type and size of energy equipment, an operation condition serving as an external factor during operation of the energy equipment, and a control condition during the operation of the energy equipment, and set the plurality of candidates as an initial group;
a Pareto solution group calculation step configured to apply the initial group determined by the initial group determination step to a genetic algorithm, and calculate a Pareto solution group that is a group of a plurality of Pareto solutions when the primary energy consumption and the system cost including the initial cost and the running cost are objective functions; and
a financial index calculation step configured to calculate a financial index of at least one of a net present value after a specific period from introduction and an internal profit rate after the specific period from the introduction when the energy equipment that individually indicates the plurality of Pareto solutions calculated by the Pareto solution group calculation step is introduced.
